(19) United States
(12) Patent Application Publication
(10) Pub. No.: US 2026/0328990 A1
(43) Pub. Date: Oct. 22, 2026

(54) LIGHT GUIDING MODULE AND ELECTRONIC DEVICE

(71) Applicant: WNC Corporation, Hsinchu (TW)

(72) Inventors: Chang-Yu HUANG, Hsinchu (TW); Yu-Kai CHIU, Hsinchu (TW)

(21) Appl. No.: 19/646,805

(22) Filed: Apr. 14, 2026

(30) Foreign Application Priority Data
Apr. 18, 2025 (TW) 114114768

(51) Int. Cl. F21V 8/00; F21V 11/16; F21V 17/06; F21V 31/00; F21W 111/00; F21Y 103/10

(52) U.S. Cl. CPC G02B 6/0096; F21V 11/16; F21V 17/06; F21V 31/005; F21V 2200/40; F21W 2111/00; F21Y 2103/10

(57) ABSTRACT

A light guiding module including a light emitting element, a light guiding element, a light blocking element, and a housing. The light emitting element provides a light. The light guiding element has a hollow space for the light to pass through. The light emitting element is disposed at one end of the light guiding element. The light blocking element is disposed at the other end of the light guiding element and includes at least one through hole. The light blocking element is configured to block a portion of the light, and another portion of the light passes through the at least one through hole. The housing abuts the light blocking element, and the other portion of the light projects on the housing to form a light indication pattern. Each of the light guiding element and the light blocking element contains a light-blocking material.

### CROSS-REFERENCE TO RELATED PATENT APPLICATION

This application claims the benefit of priority to Taiwan Patent Application

No. 114114768, filed on Apr. 18, 2025. The entire content of the above identified application is incorporated herein by reference.

### BACKGROUND

### Technical Field

The present disclosure relates to a light guiding module and an electronic device, and more particularly, to a light guiding module and an electronic device that transmit light through a housing.

### Description of Related Art

In conventional consumer electronic products, an indicator light is disposed on a housing, and the state of the electronic product is indicated based on the brightness variation of the indicator light. Currently, the indicator lights of consumer electronic products are gradually adopting a form in which light transmits through the interior of the housing, in which a light emitting element is disposed inside the housing, and when the light emitting element emits light, the generated light penetrates the housing to present an indicating pattern; when the light emitting element does not emit light, the indicating pattern is not visible on the exterior of the housing. The aforementioned indicating pattern display approach is to dispose a light blocking cover in the housing to block a portion of the light, and the light penetrating the light blocking cover forms the indicating pattern.

However, in this display approach, when displaying complex patterns, the insufficient light source around the image reduces the clarity of the pattern. If the clarity of the pattern is improved by reducing the thickness of the light blocking cover, light transmission may occur in regions outside the pattern.

In view of the above, there is an urgent need in today's electronic device market to develop a light guiding module and an electronic device that help improve the brightness and sharpness of displayed patterns.

### SUMMARY

In one aspect, the present disclosure provides a light guiding module that includes a light emitting element, a light guiding element, a light blocking element, and a housing. The light emitting element is configured to provide a light. The light guiding element has a hollow space through which the light passes. The light emitting element is disposed at one end of the light guiding element. The light blocking element is disposed at the other end of the light guiding element and includes at least one through hole. The light blocking element is configured to block a portion of the light while another portion of the light passes through the at least one through hole. The housing abuts the light blocking element, wherein the other portion of the light is projected onto the housing to form a light indicator pattern. Each of the light guiding element and the light blocking element contains a light-blocking material.

In another aspect, the present disclosure includes an electronic device that includes a substrate, a circuit unit, a light emitting element, a light guiding element, a light blocking element, and a housing. The circuit unit is disposed on the substrate. The light emitting element is disposed on the substrate and is configured to provide a light. The light guiding element has a hollow space through which the light passes, and the light emitting element is disposed at one end of the light guiding element. The light blocking element is disposed at the other end of the light guiding element and includes at least one through hole. The light blocking element is used to block a portion of the light while another portion of the light passes through the at least one through hole. The housing abuts the light blocking element, wherein the other portion of the light is projected onto the housing to form a light indicator pattern. Each of the light guiding element and the light blocking element contains a light-blocking material.

### BRIEF DESCRIPTION OF THE DRAWINGS

The present disclosure can be more fully understood by reading the following detailed description of the embodiment, with reference made to the accompanying drawings as follows:

FIG. 1 is a perspective schematic view of a light guiding module according to a first embodiment of the present disclosure.

FIG. 2 is a cross-sectional schematic view of the light guiding module according to FIG. 1.

FIG. 3 is a schematic view of a light guiding element of the light guiding module according to FIG. 1.

FIG. 4 is a cross-sectional schematic view of a housing of the light guiding module according to FIG. 1.

FIG. 5 is a schematic view illustrating transmittance of the light guiding element and a light blocking element of the light guiding module according to FIG. 1.

FIG. 6 is a perspective schematic view of a light guiding module according to a second embodiment of the present disclosure.

FIG. 7 is an exploded schematic view of the light guiding module according to FIG. 6.

FIG. 8 is a cross-sectional schematic view of the light guiding module according to FIG. 6.

FIG. 9 is a cross-sectional schematic view of a light blocking element of the light guiding module according to FIG. 6.

FIG. 10 is a perspective schematic view of an electronic device according to a third embodiment of the present disclosure.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like. Furthermore, when an element (or unit or module, etc.) is “connected” to another element, it may indicate that the element is directly connected to the other element, or it may indicate that the element is indirectly connected to the other element, i.e., other elements are disposed between the element and the other element. When it is explicitly specified that an element is “directly connected” to another element, it indicates that there are no other elements between the element and the other element.

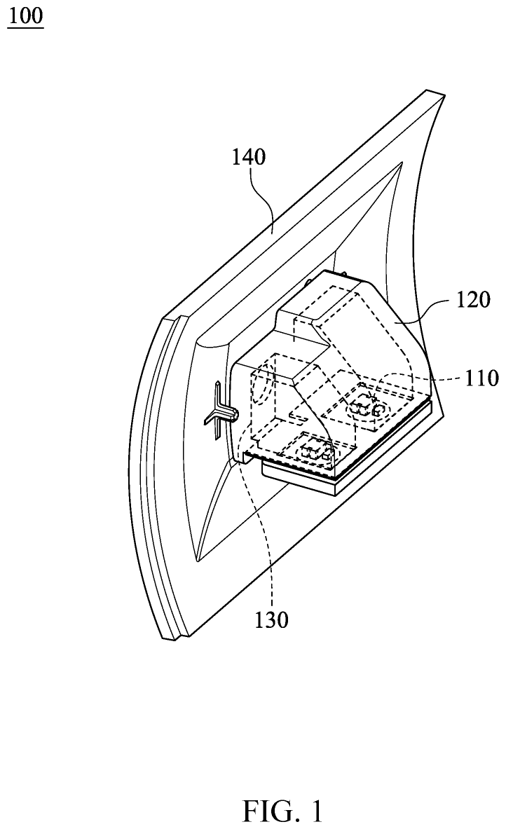

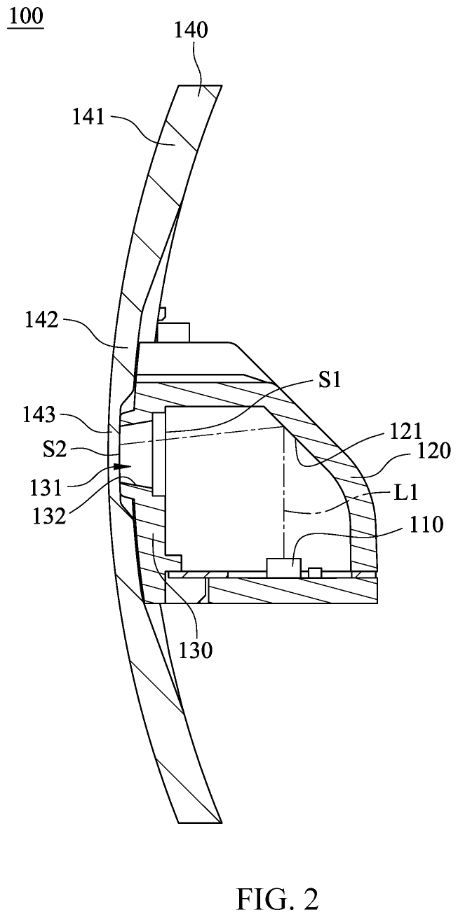

Referring to FIG. 1 and FIG. 2. FIG. 1 is a perspective schematic view of a light guiding module 100 according to a first embodiment of the present disclosure; FIG. 2 is a cross-sectional schematic view of the light guiding module 100 according to FIG. 1. The light guiding module 100 includes a light emitting element 110, a light guiding element 120, a light blocking element 130, and a housing 140. The light emitting element 110 provides a light L1. The light guiding element 120 has a hollow space through which the light L1 passes. The light emitting element 110 is disposed at one end of the light guiding element 120. The light blocking element 130 is disposed at the other end of the light guiding element 120 and includes at least one through hole 131. The light blocking element 130 is used to block a portion of the light L1, and another portion of the light L1 passes through the through hole 131. The housing 140 abuts the light blocking element 130, such that the other portion of the light L1 is projected onto the housing 140 to form a light indicator pattern. Each of the light guiding element 120 and the light blocking element 130 contains a light-blocking material.

In detail, the light guiding element 120 may be made of plastic doped with a light-blocking material, which is used to reflect the light L1 generated by the light emitting element 110 to prevent the brightness of the light L1 from decreasing; the light blocking element 130 may be made of plastic doped with a light-blocking material, and the through hole 131 on the light blocking element 130 corresponds to the light indicator pattern to be formed. The light blocking element 130 may further include an incident surface S1, an exit surface S2, and at least one annular inner wall 132. The light L1 generated by the light emitting element 110 passes through the light guiding element 120 and is emitted from the incident surface S1 of the light blocking element 130 toward the exit surface S2, and is projected onto the housing 140, thereby displaying the light indicator pattern on the exterior of the housing 140; the housing 140 abuts and adheres to the light blocking element 130. Accordingly, the light guiding module 100 of the present disclosure, by incorporating a light-blocking material into the light guiding element 120 and the light blocking element 130, undesired absorption of the light L1 as it passes through the light guiding element 120 is reduced, and the reflection of the light L1 is enhanced, thereby improving luminous efficiency of the light L1 and the edge sharpness of the light indicator pattern.

In one embodiment of the present disclosure, the light guiding element 120 and the light blocking element 130 may include a white coating, or may be made of white plastic doped with a light-blocking material, to increase the reflectivity of the light L1, but the present disclosure is not limited thereto.

Furthermore, the light guiding element 120 may include at least one light guiding inner wall 121, and the light guiding inner wall 121 is used to reflect the light L1 from the light emitting element 110 to the light blocking element 130. In other embodiments of the present disclosure, the light guiding element 120 may be non-bent, but the present disclosure is not limited thereto.

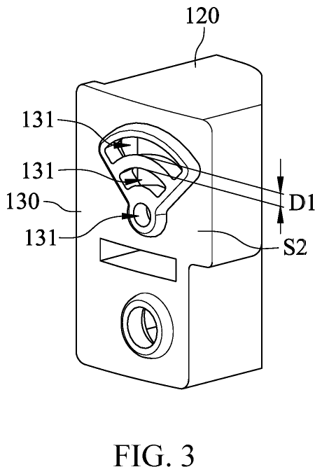

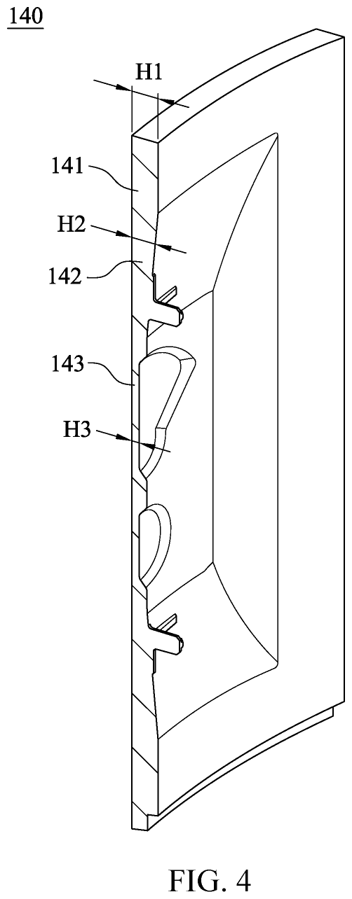

Please refer to FIGS. 1 to 4. FIG. 3 is a schematic view of the light guiding element 120 of the light guiding module 100 according to FIG. 1; FIG. 4 is a cross-sectional schematic view of the housing 140 of the light guiding module 100 according to FIG. 1. As shown in FIGS. 3 and 4, the light guiding element 120 and the light blocking element 130 are integrally formed, and the number of the through holes 131 is plural. The number and shape of the through holes 131 can be adjusted and changed according to the light indicator pattern to be presented and shown. To ensure the complete display of the light indicator pattern and maintain the clarity of the pattern, a distance D1 between any two adjacent through holes 131 can be greater than or equal to 1 millimeter. Thus, the light guiding module 100 of the present disclosure can display a light indicator pattern with a complex shape and multiple light-emitting apertures, and ensure its brightness and sharpness.

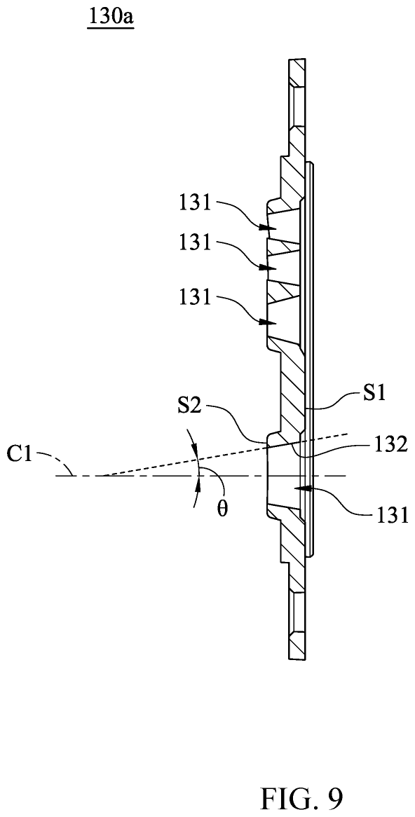

Specifically, the housing 140 may include a body region 141, a transition region 142, and a light-transmitting region 143. The body region 141 has a first thickness H1 along a direction parallel to a central axis C1 of the through hole 131 (drawn in FIG. 9). The transition region 142 is connected to the body region 141 and has a second thickness H2 along the direction parallel to the central axis C1 of the through hole 131. The light-transmitting region 143 is connected to the transition region 142 and has a third thickness H3 along the direction parallel to the central axis C1 of the through hole 131, and the light blocking element 130 corresponds to the light-transmitting region 143. The second thickness H2 is greater than the third thickness H3, and the second thickness H2 is less than the first thickness H1. In other words, the thickness of the region of the housing 140 that displays the light indicator pattern (i.e., the light-transmitting region 143) is reduced, so that the light L1 can pass through the housing 140 to the exterior thereof. In this embodiment, the first thickness H1 may be 2.5 millimeters, the third thickness H3 may be 0.7 millimeters, and the second thickness H2 is between 2.5 millimeters and 1.45 millimeters, and the transition region 142 connects the body region 141 and the light-transmitting region 143.

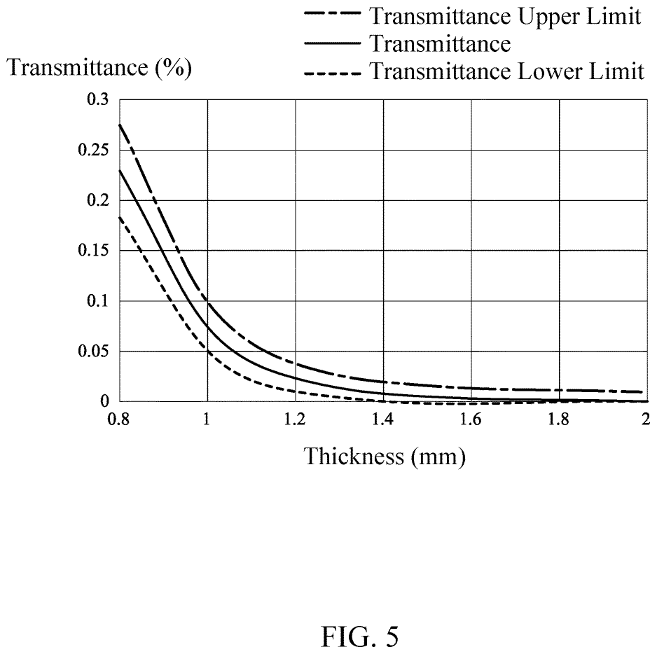

Referring to FIG. 1 and FIG. 5. FIG. 5 is a schematic view illustrating transmittance of the light guiding element 120 and the light blocking element 130 of the light guiding module 100 according to FIG. 1. Each of the light guiding element 120 and the light blocking element 130 containing a light-blocking material has a thickness X and a transmittance Y, and the upper limit of the transmittance conforms to the following formula (1):

Y≤0.001+21.457e^{-5.491X} (1).

Furthermore, the lower limit of the transmittance further conforms to the following formula (2):

Y≥29.878e^{-6.347X} (2).

Thus, the light guiding module 100 of the present disclosure can improve the overall brightness and uniformity of the light indicator pattern.

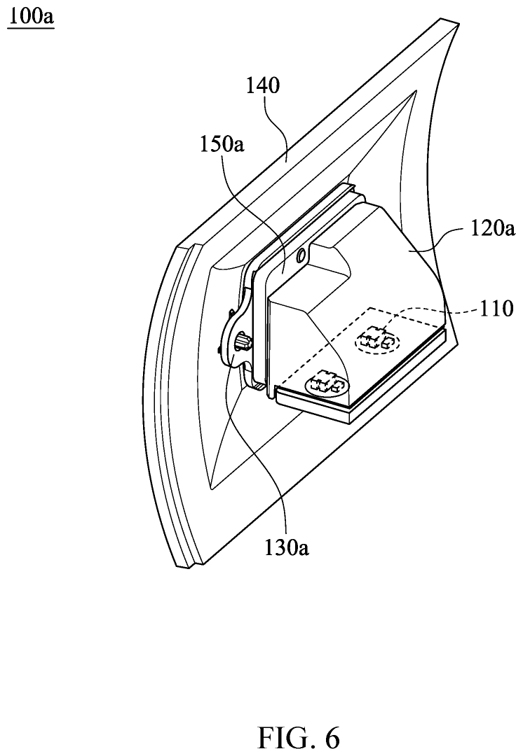

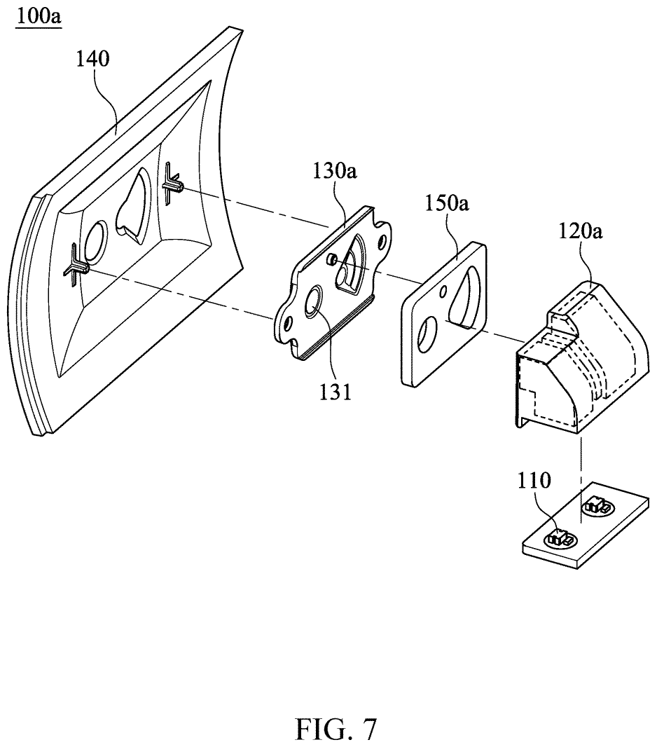

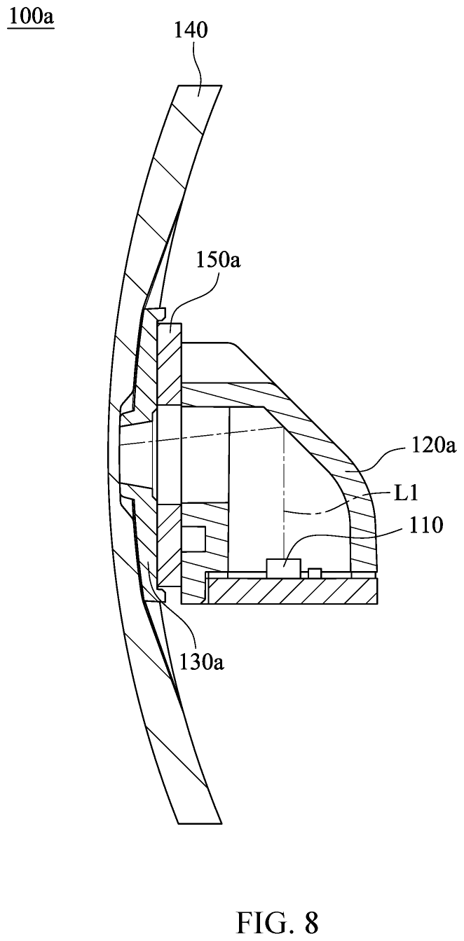

Referring to FIGS. 1 and 6 to 9. FIG. 6 is a perspective schematic view of a light guiding module 100a according to a second embodiment of the present disclosure; FIG. 7 is an exploded schematic view of the light guiding module 100a according to FIG. 6; FIG. 8 is a cross-sectional schematic view of the light guiding module 100a according to FIG. 6; and FIG. 9 is a cross-sectional schematic view of a light blocking element 130a of the light guiding module 100a according to FIG. 6. The light guiding module 100a includes a light emitting element 110, a light guiding element 120a, a light blocking element 130a, a housing 140, and a sealing member 150a. In the second embodiment, the light emitting element 110 and the housing 140 may have the same structures as the light emitting element 110 and the housing 140 in the first embodiment, and details thereof will not be repeated. In particular, the sealing member 150a is disposed between the light guiding element 120a and the light blocking element 130a, so as to prevent the light L1 from diverging from a gap between the light guiding element 120a and the light blocking element 130a, thereby ensuring the light brightness of the light indicator pattern of the light guiding module 100a.

In detail, the sealing member 150a may be a light-blocking foam or another soft, compressible light-blocking material, but the present disclosure is not limited thereto. In addition, the through hole 131 tapers from the incident surface S1 toward the exit surface S2, and the central axis C1 of the through hole 131 forms an included angle θ with the annular inner wall 132, where the included angle θ is greater than or equal to 5 degrees and less than or equal to 10 degrees. Specifically, in order to prevent light L1 from transmitting through regions of the light blocking element 130a other than the through hole 131, the annular inner wall 132 tapers from the incident surface S1 toward the exit surface S2. As such, the clarity of the light indicator pattern is ensured.

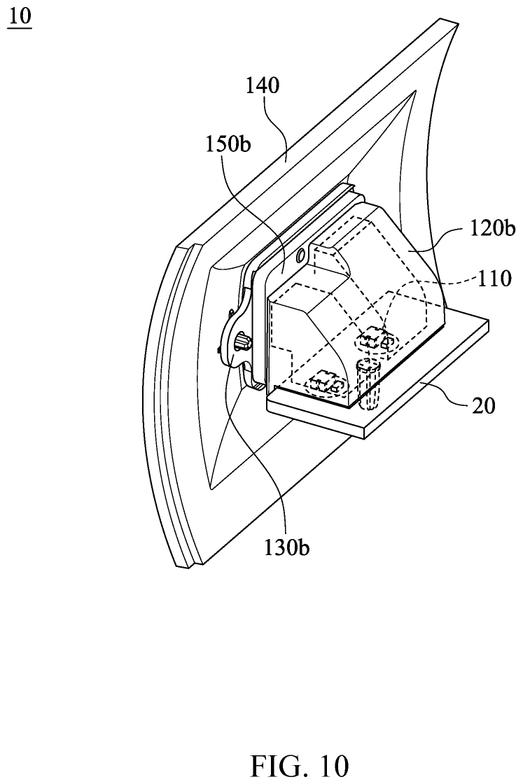

Referring to FIG. 6 and FIG. 10. FIG. 10 is a perspective schematic view of an electronic device 10 according to a third embodiment of the present disclosure. The electronic device 10 includes a substrate 20, a circuit unit (not shown), a light emitting element 110, a light guiding element 120b, a light blocking element 130b, a housing 140, and a sealing member 150b. The circuit unit is disposed on the substrate 20. The light emitting element 110 is disposed on the substrate 20 and provides a light (not shown). The light guiding element 120b has a hollow space through which the light passes. The light emitting element 110 is disposed at one end of the light guiding element 120b. The light blocking element 130b is disposed at the other end of the light guiding element 120b and includes at least one through hole 131. The light blocking element 130b is used to block a portion of the light while another portion of the light passes through the at least one through hole 131. The housing 140 abuts the light blocking element 130b, wherein the other portion of the light is projected onto the housing 140 to form a light indicator pattern. Each of the light guiding element 120b and the light blocking element 130b contains a light-blocking material, and the light guiding element 120b connects the substrate 20 and the housing 140 to form a closed space. Furthermore, the light guiding element 120b is combined with the light blocking element 130b and the sealing member 150b and connects the substrate 20 and the housing 140 to form a closed space. The term “light indicator pattern” refers to a pattern displayed by light and configured to indicate a status of the electronic device, such as a power state or a connection state, but the present disclosure is not limited thereto.

In detail, in the electronic device 10, the substrate 20 is provided with a circuit unit. The light emitting element 110 is used to switch its light emission state according to the circuit unit, and light generated from the light emitting element 110 is reflected through the light guiding element 120b and displays a light indicator pattern on the housing 140 through the light blocking element 130b. In addition, the substrate 20 may include a white coating to increase the reflectivity of the light source around the light emitting element 110, and the substrate 20 and the light guiding element 120b may be bonded by double-sided adhesive tape. In other embodiments of the present disclosure, the light guiding element may include a snap-fit structure made of a soft, compressible material, and the substrate includes a slot corresponding to the snap-fit structure. The light guiding element can be detachably fixed to the substrate via the snap-fit structure, but the present disclosure is not limited thereto.

The electronic device 10 of the present disclosure disposes the light emitting element 110 on the substrate 20, and configures the light guiding element 120b containing a light-blocking material in a bent shape to guide light toward the light blocking element 130b, thereby eliminating the need to additionally provide an extra circuit board for the light emitting element 110, reducing component and assembly costs, and increasing luminous efficiency.

In view of the above, the present disclosure embody the following advantages. First, by incorporating a light-blocking material into the light guiding element and the light blocking element, the brightness reduction caused by light absorption during the passage of light through the light guiding element is avoided, and the light reflection effect is increased to enhance the luminous efficiency of the light and the edge sharpness of the light indicator pattern. Second, a light indicator pattern with a complex shape and multiple light-emitting apertures can be displayed, and its brightness and sharpness can be ensured. Third, the overall brightness and uniformity of the light indicator pattern can be improved. Fourth, the clarity of the light indicator pattern is ensured.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A light guiding module, comprising:
a light emitting element configured to provide a light;
a light guiding element having a hollow space through which the light passes, wherein the light emitting element is disposed at one end of the light guiding element;
a light blocking element disposed at another end of the light guiding element and comprising at least one through hole, the light blocking element being configured to block a portion of the light while another portion of the light passes through the at least one through hole; and
a housing abutting the light blocking element, wherein the another portion of the light is projected onto the housing to form a light indicator pattern;
wherein each of the light guiding element and the light blocking element contains a light-blocking material.

2. The light guiding module according to claim 1, wherein the light guiding element and the light blocking element are integrally formed.

3. The light guiding module according to claim 1, further comprising:
a sealing member disposed between the light guiding element and the light blocking element.

4. The light guiding module according to claim 1, wherein the light blocking element further comprises:
an incident surface facing the light guiding element;
an exit surface facing the housing; and
at least one annular inner wall surrounding the at least one through hole;
wherein the at least one through hole tapers from the incident surface toward the exit surface, and a central axis of the at least one through hole forms an included angle with the at least one annular inner wall, the included angle being greater than or equal to 5 degrees and less than or equal to 10 degrees.

5. The light guiding module according to claim 1, wherein a number of the at least one through hole is plural, and a distance between any two adjacent ones of the plurality of through holes is greater than or equal to 1 millimeter.

6. The light guiding module according to claim 1, wherein the housing comprises:
a body region having a first thickness along a direction parallel to a central axis of the at least one through hole;
a transition region connected to the body region and having a second thickness along the direction parallel to the central axis of the at least one through hole; and
a light-transmitting region connected to the transition region and having a third thickness along the direction parallel to the central axis of the at least one through hole, wherein the light blocking element corresponds to the light-transmitting region;
wherein the second thickness is greater than the third thickness, and the second thickness is less than the first thickness.

7. The light guiding module according to claim 1, wherein at least one of the light guiding element and the light blocking element has a thickness X and a transmittance Y, and the transmittance satisfies:
Y≤0.001+21.457e^{-5.491X}.

8. The light guiding module according to claim 7, wherein at least one of the light guiding element and the light blocking element has the thickness X and the transmittance Y, and the transmittance satisfies:
Y≥29.878e^{-6.347X}.

9. The light guiding module according to claim 1, wherein the light guiding element comprises at least one light guiding inner wall configured to reflect the light from the light emitting element to the light blocking element.

10. An electronic device, comprising:
a substrate;
a circuit unit disposed on the substrate;
a light emitting element disposed on the substrate and configured to provide a light;
a light guiding element having a hollow space through which the light passes, wherein the light emitting element is disposed at one end of the light guiding element;
a light blocking element disposed at another end of the light guiding element and comprising at least one through hole, the light blocking element being configured to block a portion of the light while another portion of the light passes through the at least one through hole; and
a housing abutting the light blocking element, wherein the another portion of the light is projected onto the housing to form a light indicator pattern;
wherein each of the light guiding element and the light blocking element contains a light-blocking material.

11. The electronic device according to claim 10, wherein the light guiding element and the light blocking element are integrally formed.

12. The electronic device according to claim 10, further comprising:
a sealing member disposed between the light guiding element and the light blocking element.

13. The electronic device according to claim 10, wherein the light blocking element further comprises:
an incident surface facing the light guiding element;
an exit surface facing the housing; and
at least one annular inner wall surrounding the at least one through hole;
wherein the at least one through hole tapers from the incident surface toward the exit surface, and a central axis of the at least one through hole forms an included angle with the at least one annular inner wall, the included angle being greater than or equal to 5 degrees and less than or equal to 10 degrees.

14. The electronic device according to claim 10, wherein a number of the at least one through hole is plural, and a distance between any two adjacent ones of the plurality of through holes is greater than or equal to 1 millimeter.

15. The electronic device according to claim 10, wherein the housing accommodates the substrate, the circuit unit, the light emitting element, the light guiding element, and the light blocking element, and comprises:
a body region having a first thickness along a direction parallel to a central axis of the at least one through hole;
a transition region connected to the body region and having a second thickness along the direction parallel to the central axis of the at least one through hole; and
a light-transmitting region connected to the transition region and having a third thickness along the direction parallel to the central axis of the at least one through hole, wherein the light blocking element corresponds to the light-transmitting region;
wherein the second thickness is greater than the third thickness, and the second thickness is less than the first thickness.

16. The electronic device according to claim 10, wherein at least one of the light guiding element and the light blocking element has a thickness X and a transmittance Y, and the transmittance satisfies:
Y≤0.001+21.457e^{-5.491X}.

17. The electronic device according to claim 16, wherein at least one of the light guiding element and the light blocking element has the thickness X and the transmittance Y, and the transmittance satisfies:
Y≥29.878e^{-6.347X}.

18. The electronic device according to claim 10, wherein the light guiding element comprises at least one light guiding inner wall configured to reflect the light from the substrate to the light blocking element.

19. The electronic device according to claim 10, wherein the circuit unit is a processor or an input-output port.

20. The electronic device according to claim 10, wherein the light guiding element connects the substrate and the housing to form a closed space.
